(19) United States
(12) Patent Application Publication
(10) Pub. No.: US 2026/0179118 A1
(43) Pub. Date: Jun. 25, 2026

(54) DIGITAL PROMOTION PROCESSING SYSTEM INCLUDING ARTIFICIAL INTELLIGENCE (AI) MODEL BASED SHOPPER MATCHING AND RELATED METHODS

(71) Applicant: Inmar Brand Solutions, Inc., Winston-Salem, NC (US)

(72) Inventors: Sean A. BRISCOE, Greensboro, NC (US); Jeffery A. CLOUSE, Jamestown, NC (US)

(21) Appl. No.: 19/402,727

(22) Filed: Nov. 26, 2025

Related U.S. Application Data
(60) Provisional application No. 63/737,664, filed on Dec. 21, 2024.

(51) Int. Cl. G06Q 30/0251

(52) U.S. Cl. CPC G06Q 30/0255; G06Q 30/0271

(57) ABSTRACT

A digital promotion processing system may include a shopper device associated with a given shopper, and a promotion processing server. The promotion processing server may be configured to obtain a product purchase history associated with the given shopper and operate a first artificial intelligence (AI) model to assign at least one shopper characteristic tag from among shopper characteristic tags to the given shopper based upon the product purchase history. The promotion processing server may also be configured to operate a second AI model to assign at least one product characteristic tag from among product characteristic tags to products for purchase and determine a digital promotion for the given shopper based upon matching the at least one shopper characteristic tag and the at least one product characteristic tag. The promotion processing server may also be configured to communicate the digital promotion to the shopper device.

### RELATED APPLICATION

The present invention claims the priority benefit of provisional application Ser. No. 63/737,664 filed on Dec. 21, 2024, the entire contents of which are herein incorporated by reference.

### TECHNICAL FIELD

The present invention relates to the field of digital promotion generation, and, more particularly, to generating a digital promotion to a shopper based upon artificial intelligence (AI) assigned tags, and related methods.

### BACKGROUND

Sales of a particular product or service may be based upon how well that product or service is marketed to a shopper. One form of marketing or promotion is a coupon, typically in paper form, for a discount toward the product or service. Some coupons may be retailer specific, for example, only redeemable for the discount at a particular retailer, while other coupons may be product specific from a manufacturer and redeemable at any retailer.

A coupon, while typically in paper form, may be in digital form and may be referred to as a digital promotion. A digital promotion may be selected or “clipped” via a mobile phone and saved to a digital wallet for redemption at a point-of-sale (POS) terminal, for example. A typical coupon is applicable to a given product and has a redeemable value that may vary based upon, for example, the quantity of a given item, brand of item, size of the product in terms of packaging, and/or the price point of the given item. A typical coupon may also be redeemable only at a given retailer and/or within a threshold time period.

A typical coupon includes text describing details of the coupon, including, for example, the product or product for purchase to which the coupon is redeemable, an expiration of the coupon, and the redeemable value. A typical coupon may also include an exemplary image of a product, which may be a product for purchase to which the coupon is redeemable, or another product for purchase. Some coupons may not include an image.

A targeted promotion is a strategic approach used by a retailer to reach a shopper or group of shoppers, for example, with a personalized offer. A typical promotion, for example, may provide generic results. However, a targeted promotion may allow a retailer to use knowledge of a shopper or shoppers, including their behaviors, to categorize and group them for purposes of providing them with a promotion matched for their category or group.

### SUMMARY

A digital promotion processing system may include a shopper device associated with a given shopper, and a promotion processing server. The promotion processing server may be configured to obtain a product purchase history associated with the given shopper, and operate a first artificial intelligence (AI) model to assign at least one shopper characteristic tag from among a plurality of shopper characteristic tags to the given shopper based upon the product purchase history. The promotion processing server may be configured to operate a second AI model to assign at least one product characteristic tag from among a plurality of product characteristic tags to a plurality of products for purchase, and determine a digital promotion for the given shopper based upon matching the at least one shopper characteristic tag and the at least one product characteristic tag. The promotion processing server may also be configured to communicate the digital promotion to the shopper device.

The promotion processing server may be configured to obtain a further product purchase history associated with another shopper and operate the first artificial intelligence (AI) model to assign at least one shopper characteristic tag from among the plurality of shopper characteristic tags to the another shopper based upon the further product purchase history, for example. The promotion processing server may also be configured to determine the digital promotion for the given shopper based upon matching the at least one shopper characteristic tag for the given and further shoppers and the at least one product characteristic tag.

The promotion processing server may be configured to obtain a further product purchase history associated with another shopper and operate the first artificial intelligence (AI) model to assign the at least one shopper characteristic tag to the given shopper based upon the further product purchase history, for example. The promotion processing server may be configured to operate at least one of the first and second AI models based upon bootstrap aggregation.

The plurality of shopper characteristic tags may include at least one of diet preference tags, cuisine preference tags, and cooking habit tags, for example. The plurality of product characteristic tags may include at least one of ingredient tags, nutritional value tags, and food preparation type tags, for example. The digital promotion may be redeemable toward purchase of a product from among the plurality of products for purchase.

The promotion processing server may be configured to determine a plurality of digital promotions including the digital promotion for the given shopper based upon matching the at least one shopper characteristic tag and the at least one product characteristic tag, rank the plurality of digital promotions based upon the matched at least one shopper characteristic tag and at least one product characteristic tag, and communicate the ranked plurality of digital promotions to the shopper device. The plurality of digital promotions may be redeemable toward the plurality of products for purchase, for example. The promotion processing server may be configured to determine a likelihood that the given shopper will purchase the products for purchase associated with the plurality of digital promotions and rank the plurality of digital promotions based upon the likelihood, for example.

A method aspect is directed to a method of processing a digital promotion. The method may include using a promotion processing server to obtain a product purchase history associated with a given shopper and operate a first artificial intelligence (AI) model to assign at least one shopper characteristic tag from among a plurality of shopper characteristic tags to the given shopper based upon the product purchase history. The method may also include using the promotion processing server to operate a second AI model to assign at least one product characteristic tag from among a plurality of product characteristic tags to a plurality of products for purchase and determine a digital promotion for the given shopper based upon matching the at least one shopper characteristic tag and the at least one product characteristic tag. The method may also include using the digital processing server to communicate the digital promotion to a shopper device associated with the given shopper.

A computer readable medium aspect is directed to a non-transitory computer readable medium for processing a digital promotion. The non-transitory computer readable medium includes computer executable instructions that when executed by a processor cause the processor to perform operations. The operations may include obtaining a product purchase history associated with a given shopper and operating a first artificial intelligence (AI) model to assign at least one shopper characteristic tag from among a plurality of shopper characteristic tags to the given shopper based upon the product purchase history. The operations may also include operating a second AI model to assign at least one product characteristic tag from among a plurality of product characteristic tags to a plurality of products for purchase and determining a digital promotion for the given shopper based upon matching the at least one shopper characteristic tag and the at least one product characteristic tag. The operations may also include communicating the digital promotion to a shopper device associated with the given shopper.

### BRIEF DESCRIPTION OF THE DRAWINGS

FIG. 1 is a schematic diagram of a digital promotion processing system in accordance with an embodiment.

FIG. 2 is a schematic block operational diagram of the digital promotion processing system of FIG. 1.

FIG. 3 is a schematic block diagram of the digital promotion processing system of FIG. 1.

FIG. 4 is a flowchart of operation of the promotion processing server of FIG. 3.

FIG. 5 is schematic operational diagram of a digital promotion processing system in accordance with another embodiment.

FIG. 6 is a flowchart of operation of the promotion processing server of FIG. 5.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

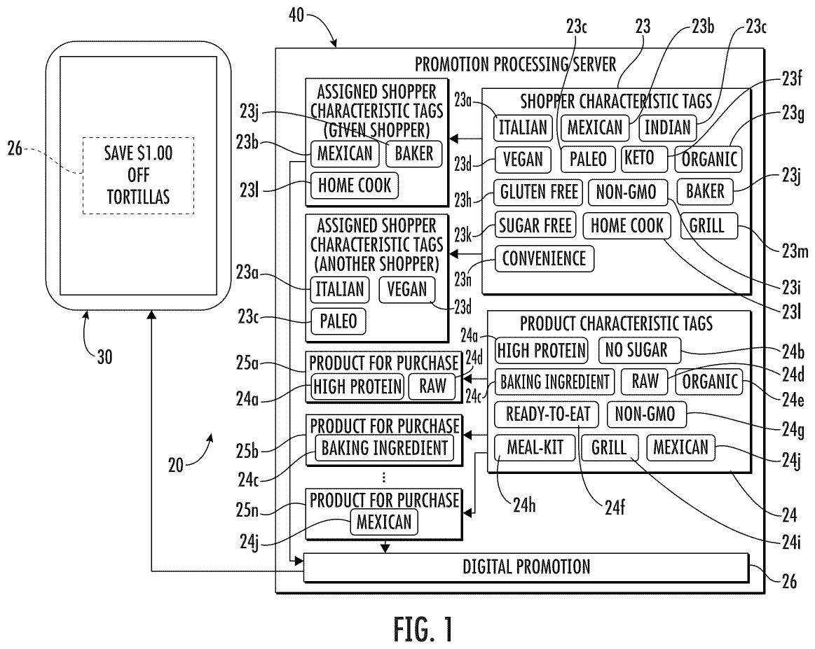

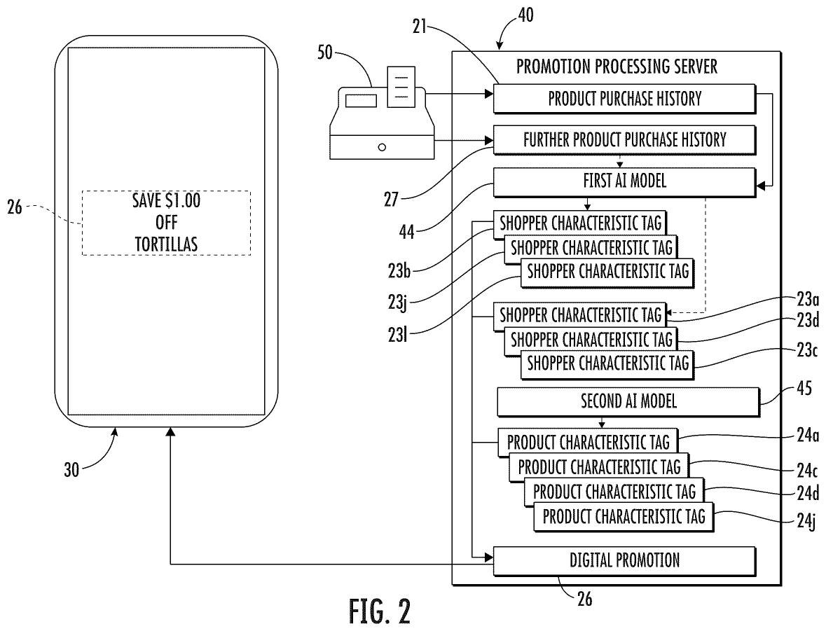

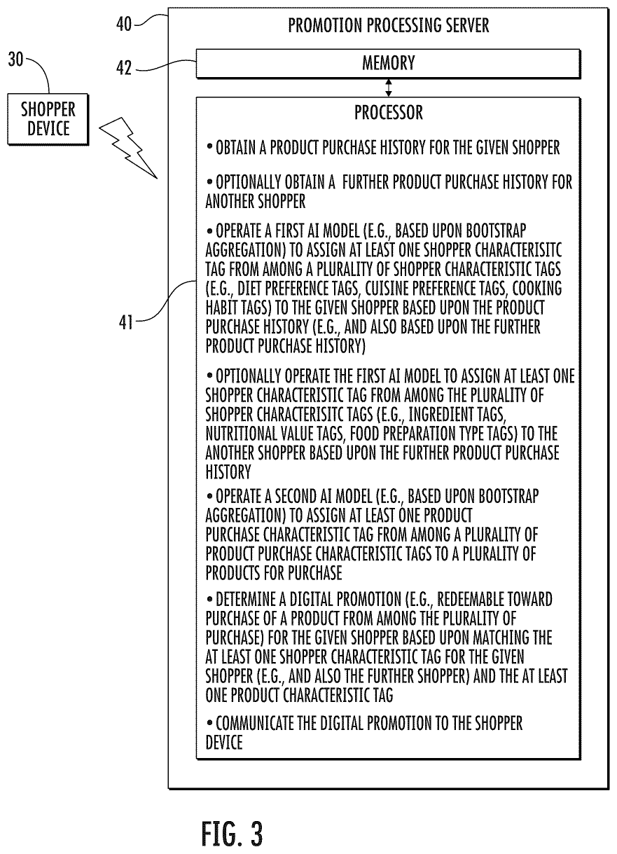

Referring initially to FIGS. 1-3, a digital promotion processing system 20 includes a shopper device 30. The shopper device 30 is associated with a given shopper. The shopper device 30 is illustratively in the form of a mobile wireless communications device or smartphone. The shopper device 30 may be in the form of another type of device, for example, a laptop computer, desktop computer, tablet computer, or wearable computer.

The digital promotion processing system 20 also includes a promotion processing server 40. The promotion processing server 40 includes a processor 41 and an associated memory 42. While operations of the promotion processing server 40 are described herein, those operations are performed through cooperation between the processor 41 and the associated memory 42.

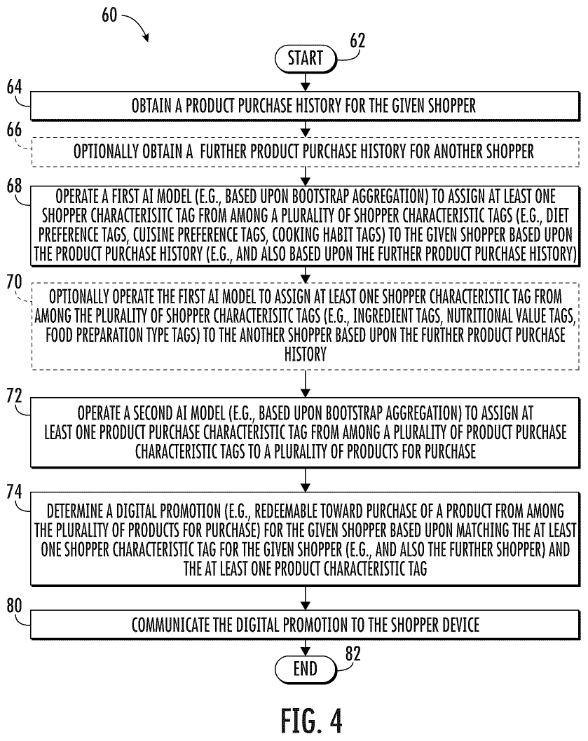

Referring now to the flowchart 60 in FIG. 4, beginning at Block 62, operations of the promotion processing server 40 will now be described. At Block 64, the promotion processing server 40 obtains a product purchase history 21 associated with the given shopper. The product purchase history 21 may include historical shopping data on a per-basket or per-shopping trip basis. The product purchase history 21 may include, for each shopping basket, time and date, quantities and descriptions of products purchased, prices of purchased products, unique product identifiers (e.g., stock keeping unit (SKU), product look-up (PLU), uniform product code (UPC)), and/or data regarding whether a coupon or promotion was applied and its redemption value.

The promotion processing server 40 may obtain the product purchase history 21 based upon communication with a point-of-sale (POS) device 50. The POS device 50 may be a physical POS device located in a physical store, for example. The POS device 50 may be a virtual POS device permitting purchase of products and/or services via an e-commerce platform, as will be appreciated by those skilled in the art. As a physical POS device 50, as products, for example, as part of a given shopping basket or shopping trip, are scanned, the product purchase history 21 is updated. In an embodiment, the product purchase history 21 may be updated based on a per-shopping trip basis, for example, as determined based upon the close of the purchase transaction at the POS device 50.

The promotion processing server 40 may optionally, at Block 66, obtain a further product purchase history 27 associated with another shopper. The promotion processing server 40 may obtain the further product purchase history 27 similarly to the product purchase history 21 described above with respect to the given shopper.

The promotion processing server 40, at Block 68, operates a first artificial intelligence (AI) model 44. The first AI model 44 assigns one or more shopper characteristic tags 23b, 23j, 23l to the given shopper based upon the product purchase history 21. The promotion processing server 40 may

optionally additionally operate the first AI model 44 to assign the shopper characteristic tags 23b, 23j, 23l to the given shopper based upon the further product purchase history 27 (i.e., the product purchase history associated with the another shopper). In other words, the further product purchase history 27 may be used to determine the shopper characteristic tags 23b, 23j, 23l of the given shopper based upon a similarity to the another shopper or other shoppers.

The shopper characteristic tags 23b, 23j, 23l are assigned from among a larger set or group of shopper characteristics tags 23. The shopper characteristic tags 23 may be indicative of characteristics and behaviors of the given shopper. The shopper characteristic tags 23 may include one or more of diet preference tags (e.g., vegan 23d, Paleo 23e, Keto 23f, etc.), cuisine preference tags (Italian 23a, Mexican 23b, Indian 23c, BBQ, etc.), cooking habit tags (e.g., baker 23j, weekend griller 23m, convenience cooker 23n, home cooker 23l, etc.), and health concern tags (e.g., non-GMO 23i, gluten free 23h, organic 23g, low-salt, sugar free 23k, etc.). Of course, the shopper characteristic tags 23 may include other and/or additional tags or tag types.

The first AI model 44 may operate or learn continuously, for example, updating by continually reassigning and/or assigning the shopper characteristic tags 23. As will be appreciated by those skilled in the art, the first AI model 44 may accept as input thereto the product purchase histories 21, 27, including product description, unique product identifier, price, quantity, store location, and/or whether a promotion was applied. The first AI model 44 may alternatively or additionally accept as input previously assigned shopper characteristic tags 23. Further details of the first AI model 44 are described below.

When, for example, the promotion processing server 40, obtains a further product purchase history 27 (Block 66), the promotion processing server may optionally operate the first AI model 44 to assign one or more of the shopper characteristics tags 23a, 23d, 23e (from among the shopper characteristic tags 23) to the another shopper (Block 70). The promotion processing server 40 may assign the shopper characteristic tags 23 to the another shopper similarly to the given shopper, for example, as described above.

The promotion processing server 40, at Block 72, operates a second AI model 45. The second AI model 45 assigns one or more product characteristic tags 24a, 24c, 24d, 24j to products for purchase 25a-25n. The assigned product characteristic tags 24a, 24c, 24d, 24j are selected or assigned from among a larger set or group of product characteristic tags 24.

The product characteristics tags 24 may be indicative of characteristics of products for purchase 25a-25n and are assigned to each product for purchase. Exemplary product characteristic tags 24 may include one or more ingredient tags (e.g., the ingredients that make up the product for purchase 25a-25n), nutritional value tags (e.g., high-protein 24a, sugar-free 24b, low-sodium, etc.), and food preparation tags (e.g., ready-to-eat 24f, raw 24d, meal kit 24h, ingredient-for such as baking ingredient 24c, etc.). In embodiments, there may be overlap between the shopper characteristic tags 23 and the product characteristics tags 24 (e.g., organic 24e, non-GMO 24g, grill 24i, Mexican cuisine 24j). The second AI model 45 may accept, as input, similarly to the first AI model 44, previously assigned product characteristic tags 24.

Additional details of the first and second AI models 45, 45 will now be described. The first and second AI models 44, 45 may each be in the form of a multi-modal AI model, which may be considered a foundational model or a large language model (LLM), for example. Exemplary multi-modal AI models may include Gemini and/or GPT4.0. Of course, other models may be used. As a multi-modal AI model 44, 45, for example, the text (e.g., of product descriptions, from the respective product purchase histories 21, 27 may be accepted as input, and the assigned shopper and product characteristic tags 23, 24 may be output therefrom. The first and second AI models 44, 45 may also accept, as input thereto, text from the shopper and product characteristic tags 23, 24 and/or the tags themselves, for example, from the another shopper and/or as products are being purchased (and thus the product purchase histories 21, 27 are being updated).

As will be appreciated by those skilled in the art, a multi-modal AI model 44, 45 may accept, as input, text and/or image data, and output, text and/or image data. Each multi-modal AI model 44, 45, for example, when in the form of an LLM, is a machine learning technique that provides language understanding and synthesis services. Each multi-modal AI model 44, 45, for example, may acquire these abilities by learning statistical relationships from text or images during a computationally intensive self-supervised and semi-supervised training process. Each multi-modal AI model 44, 45 may be an artificial neural network and may be built with a transformer-based architecture, for example. Each multi-modal AI model 44, 45 may be implemented using other architectures, such as, for example, recurrent neural network variants and various state space models.

Each multi-modal AI model 44, 45 may operate as a form of generative AI, by taking, as input, the respective product purchase histories 21, 27 (e.g., text or numbers therefrom), and repeatedly predicting the next token (e.g., word, and/or text) to determine or assign the shopper and product characteristic tags 23, 24, respectively. While multi-modal AI models 44, 45 have been described, it should be noted that other and/or additional multi-modal AI models or LLMs, as described herein, operate in a similar fashion.

The first and second AI models 44, 45 may bootstrap each other, for example, over time, or operate based upon the bootstrap aggregation. Bootstrapping estimates a distribution of an estimator by resampling of data or a model estimated from the data, such as, for example, the first and second AI models 44, 45. More particularly, as will be appreciated by those skilled in the art, as applied to the first and second AI models 44, 45, bootstrap aggregating, or bootstrapping, is a form of machine learning that is an ensemble metaheuristic for primarily reducing variance (e.g., as opposed to bias). The use of bootstrapping may increase stability and accuracy of learning classifications and regression algorithms and may also reduce overfitting.

As it is applied to the first and second AI models 44, 45, a training set D may include the product purchase history 21 of the given shopper and optionally the further product purchase history 27 of the another shopper (e.g., and/or other shoppers). The training set D may alternatively or additionally include shopper or product characteristic tags 23, 24. The training set D may have a size n, and the bootstrap aggregation generates m new training sets Di, each of size n′ by sampling from D uniformly and with replacement. By sampling with replacement, some observations may be repeated in each Dᵢ. If n′=n, then for large n, the set Dᵢ may have (1-1/e) of the unique samples of D, with the rest of the samples being duplicates (i.e., bootstrap sample). The first and second AI models 44, 45, may be fitted with the above bootstrap samples and combined by averaging the output (for regression) or voting (for classification). Bootstrapping may assist other machine learning or AI processes, for example, those described above, by increasing stability in what may be considered relatively unstable processes (e.g., artificial neural networks, classification and regression trees, and subset selection in linear regression).

The promotion processing server 40 determines a digital promotion 26 for the given shopper based upon matching the assigned shopper characteristics tag or tags 23b, 23j, 23l to the assigned product characteristic tag or tags 24a, 24c, 24d, 24j (Block 74). In other words, for each shopper characteristic tag 23b, 23j, 23l assigned to the given shopper, the promotion processing server 40 determines whether it matches each assigned product characteristic tag 24a, 24c, 24d, 24j. In embodiments where a further product purchase history 27 has been obtained for the another shopper, the promotion processing server 40 may optionally determine the digital promotion 26 based upon matching the shopper characteristic tags 23 for the another shopper to the product characteristic tag. In other words, the another shopper may serve as a basis for determining the digital promotion 26 for the given shopper, for example, where similarities between the given shopper and the another shopper may exist (e.g., same or similar shopper characteristics tags 23).

Those skilled in the art will appreciate that while the shopper characteristic tags 23 and the product characteristic tags 24 may not be identical, the promotion processing server 40 will match the products for purchase 25a-25n to the given shopper based upon matching criteria. For example, if the given shopper has been assigned a gluten free shopper characteristic tag 23h, the given shopper will be matched with gluten free products for purchase 25a-25n. Similarly, if the given shopper has been assigned a Mexican cuisine preference tag 23b, the given shopper may be matched to taco seasoning, salsa, tortillas, nacho chips, etc. (all having a Mexican cuisine product characteristic tag 24j associated therewith), but may not be matched to pasta, curry, etc., for example.

It will be understood by those skilled in the art that the matching performed by the promotion processing server 40 may not be a binary match but may be based upon a degree of match. For example, if the given shopper has been assigned a Mexican cuisine shopper characteristic tag 23b, it does not mean that the given shopper cannot or will be matched with other cuisine types, for example, Italian, BBQ, etc. However, the degree of matching may serve as a basis, for example, by way of ranking, and thus a determination of the digital promotion 26, as will be described in further detail below. As will be appreciated by those skilled in the art, by way of the matching, the promotion processing server 40 is able to more accurately identify the products for purchase 25a-25n that the given shopper is more likely to have an interest, and act upon the increased likelihood of interest by way of the digital promotion 26.

The digital promotion 26 is illustratively in the form of a digital coupon that is redeemable toward purchase of product for purchase from among the products for purchase 25a-25n. With respect to the above example whereby Mexican cuisine is matched between the shopper and product characteristic tags 23b, 24j the promotion processing server 40 may generate the digital promotion 26 to be redeemable toward any one or more of the products for purchase 25a-25n described above - tortillas, taco seasoning, salsa, nacho chips. In an embodiment, the promotion processing server 40 may determine the digital promotion to be for another product for purchase 25a-25n that is not associated with the matching between the shopper and product characteristic tags 23, 24.

More particularly, referring again to the Mexican cuisine example, above, the promotion processing server 40 may determine the digital promotion 26 to be for a Spanish cuisine item, for example, to entice the given shopper to try or purchase a Spanish cuisine product based upon a similarity of cuisine type to Mexican. In another example, the digital promotion 26 may be determined to be a cuisine type, for example, Italian, based upon a similarity of other shoppers with matching Mexican cuisine tags that also have matches with Italian food cuisine tags or products for purchase 25a-25n.

At Block 80, the promotion processing server 40 communicates the digital promotion 26 to the shopper device 30, for example, wirelessly and for display thereat. The given shopper may provide input (e.g., via a touch screen display) to save the digital promotion to a digital wallet associated with the given shopper. The digital wallet, and thus the digital promotion 26, may be stored on the shopper device 30, on the promotion processing server 40 (e.g., in the memory 42), or on both the shopper device and the promotion processing server. Operations end at Block 82.

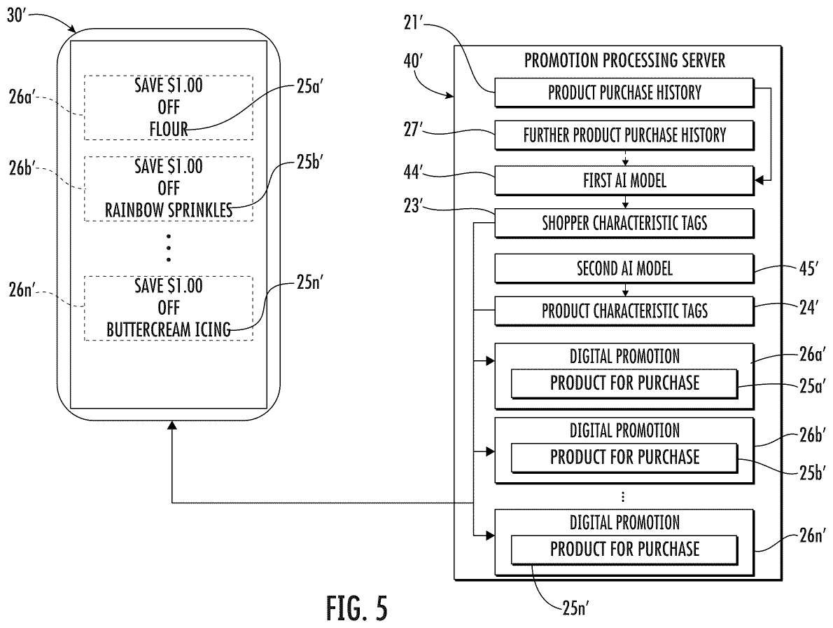

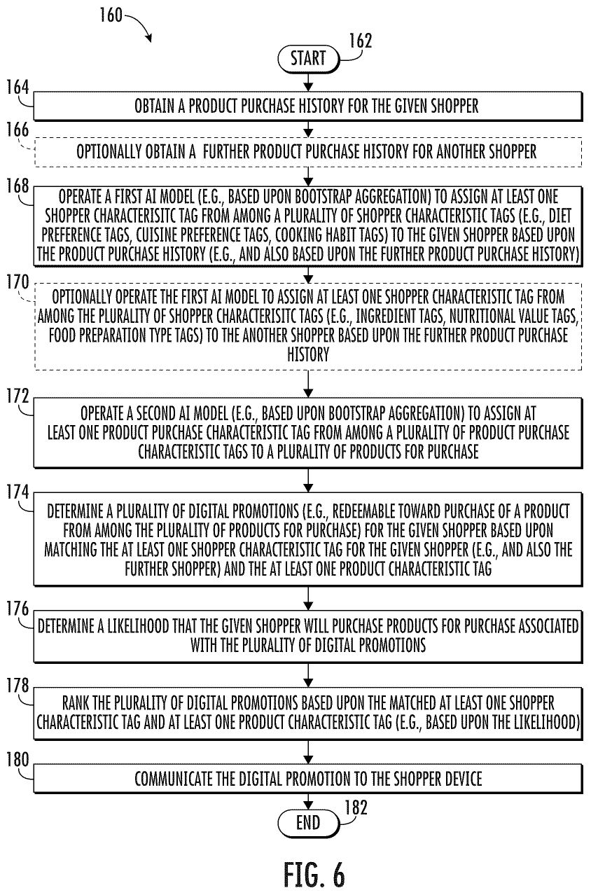

Referring now to FIG. 5 and the flowchart 160 in FIG. 6, beginning at Block 162, in another embodiment, the promotion processing server 40′ determines more than one digital promotion 26a′-26n′ for the given shopper (Block 174). Each digital promotion 26a′-26n′ is determined based upon matching the shopper characteristic tags 23′ and the product characteristic tags 24′ as described above.

At Block 178, the promotion processing server 40′ ranks the digital promotions 26a′-26n′ based upon the matching of the shopper characteristic tags 23′ and the product characteristic tags 24′, and more particularly, the degree of matching or the number of matching tags. More particularly, at Block 176, the promotion processing server 40′ may determine a likelihood that the given shopper will purchase the products for purchase 25a′-25n′ associated with the digital promotions 26a′-26n′. The promotion processing server 40′ may determine the likelihood based upon a scoring model, for example, by assigning a score to each match and to the aggregate matches. Each match of the shopper characteristic tags 23′ and the product characteristic tags 24′ may increase a score, and the matching of some tags may be weighted to increase the overall score.

The promotion processing server 40′ may also operate a machine learning algorithm that accepts as input, for example, the product purchase history 21′ for the given shopper and the further product purchase history 27′ for the another shopper or shoppers. Promotion redemption data from the product purchase histories 21', 27′ may be used to increase the score or likelihood since other similarly situated shoppers may be used for an indication or insight into the given shopper's likely behavior. Previous redemption data for the given shopper and/or other shopper or shoppers may also serve as an indication of the likelihood the given shopper will purchase the products for purchase 25a′-25n′. Product purchase frequency or cadence data from the product purchase histories 21', 27′ for the given shopper and/or the other shopper or shoppers may also be used to determine the likelihood.

The machine learning algorithm may thus output the score, for example. The score may be a numerical score or an alphanumeric score, for example. The score may be internal—that is relative to the other digital promotions 26a′-26n′. The machine learning model may be updated as the product purchase histories 21′, 27′ are updated, for example, along the lines described below. The promotion processing server 40′ may rank the digital promotions 26a′-26n′ based upon the determined likelihood (Block 178).

An example may be a “baker” shopper being interested in purchasing “baking ingredient” products. In this example, the “baking ingredient” products may be ranked and presented to the given shopper. In an embodiment, the ranking may also be affected by the mode at which the digital promotions 26a′-26n′ are presented to the shopper. For example, the promotion processing server 40′ may rank the digital promotions 26a′-26n′ also based upon whether the ranked digital promotions will be displayed on the shopper device 30′ via an email, via a retailer application, an online or web-based coupon portal or website, or via social media.

The promotion processing server 40′ communicates the ranked digital promotions 26a′-26n′ to the shopper device 30′ for display thereat (e.g., in ranked fashion or as a ranked list) (Block 180). Similarly to the above-described embodiments, the digital promotions 26a′-26n', as ranked, are redeemable toward corresponding products for purchase 25a′-25n′. The digital promotions 26a′-26n′ may each be saved to a digital wallet associated with the given shopper, for example.

Embodiments not specifically described, such as, first and second AI Models 44′, 45′, are similar to first and second AI Models 44, 45, above. Operations not specifically described, such as, for example, the operations at Blocks 166, 168, 170, and 172, are similar to the operations at Blocks 66, 68, 70, and 72. Operations end at Block 182.

A method aspect is directed to a method of processing a digital promotion. The method includes using a promotion processing server to obtain a product purchase history 21 associated with a given shopper and operate a first artificial intelligence (AI) model 44 to assign at least one shopper characteristic tag 23 from among a plurality of shopper characteristic tags to the given shopper based upon the product purchase history. The method also includes using the promotion processing server to operate a second AI model 45 to assign at least one product characteristic tag 24 from among a plurality of product characteristic tags to a plurality of products for purchase 25a-25n and determine a digital promotion 26 for the given shopper based upon matching the at least one shopper characteristic tag and the at least one product characteristic tag. The method also includes using the digital processing server 40 to communicate the digital promotion 26 to a shopper device 30 associated with the given shopper.

A computer readable medium aspect is directed to a non-transitory computer readable medium for processing a digital promotion. The non-transitory computer readable medium includes computer executable instructions that when executed by a processor 41 cause the processor to perform operations. The operations include obtaining a product purchase history 21 associated with a given shopper and operating a first artificial intelligence (AI) model 44 to assign at least one shopper characteristic tag 23 from among a plurality of shopper characteristic tags to the given shopper based upon the product purchase history. The operations also include operating a second AI model 45 to assign at least one product characteristic tag 24 from among a plurality of product characteristic tags to a plurality of products for purchase 25a-25n and determining a digital promotion 26 for the given shopper based upon matching the at least one shopper characteristic tag and the at least one product characteristic tag. The operations also include communicating the digital promotion 26 to a shopper device 30 associated with the given shopper.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A digital promotion processing system comprising:
a shopper device associated with a given shopper; and
a promotion processing server configured to
obtain a product purchase history associated with the given shopper,
operate a first artificial intelligence (AI) model to assign at least one shopper characteristic tag from among a plurality of shopper characteristic tags to the given shopper based upon the product purchase history,
operate a second AI model to assign at least one product characteristic tag from among a plurality of product characteristic tags to a plurality of products for purchase,
determine a digital promotion for the given shopper based upon matching the at least one shopper characteristic tag and the at least one product characteristic tag, and
communicate the digital promotion to the shopper device.

2. The digital promotion processing system of Claim wherein the promotion processing server is configured to:
obtain a further product purchase history associated with another shopper;
operate the first artificial intelligence (AI) model to assign at least one shopper characteristic tag from among the plurality of shopper characteristic tags to the another shopper based upon the further product purchase history; and
determine the digital promotion for the given shopper based upon matching the at least one shopper characteristic tag for the given and further shoppers and the at least one product characteristic tag.

3. The digital promotion processing system of claim 1 wherein the promotion processing server is configured to:
obtain a further product purchase history associated with another shopper; and
operate the first artificial intelligence (AI) model to assign the at least one shopper characteristic tag to the given shopper based upon the further product purchase history.

4. The digital promotion processing system of claim 1 wherein the promotion processing server is configured to operate at least one of the first and second AI models based upon bootstrap aggregation.

5. The digital promotion processing system of claim 1 wherein the plurality of shopper characteristic tags comprises at least one of diet preference tags, cuisine preference tags, and cooking habit tags.

6. The digital promotion processing system of claim 1 wherein the plurality of product characteristic tags comprises at least one of ingredient tags, nutritional value tags, and food preparation type tags.

7. The digital promotion processing system of claim 1 wherein the digital promotion is redeemable toward purchase of a product from among the plurality of products for purchase.

8. The digital promotion processing system of claim 1 wherein the promotion processing server is configured to determine a plurality of digital promotions including the digital promotion for the given shopper based upon matching the at least one shopper characteristic tag and the at least one product characteristic tag, rank the plurality of digital promotions based upon the at least one matched shopper characteristic tag and the at least one product characteristic tag, and communicate the ranked plurality of digital promotions to the shopper device.

9. The digital promotion processing system of claim 8 wherein the plurality of digital promotions are redeemable toward the plurality of products for purchase; and wherein the promotion processing server is configured to determine a likelihood that the given shopper will purchase the products for purchase associated with the plurality of digital promotions and rank the plurality of digital promotions based upon the likelihood.

10. A promotion processing server comprising:
a processor and an associated memory configured to
obtain a product purchase history associated with a given shopper,
operate a first artificial intelligence (AI) model to assign at least one shopper characteristic tag from among a plurality of shopper characteristic tags to the given shopper based upon the product purchase history,
operate a second AI model to assign at least one product characteristic tag from among a plurality of product characteristic tags to a plurality of products for purchase,
determine a digital promotion for the given shopper based upon matching the at least one shopper characteristic tag and the at least one product characteristic tag, and
communicate the digital promotion to a shopper device associated with the given shopper.

11. The promotion processing server of claim 10 wherein the processor is configured to:
obtain a further product purchase history associated with another shopper;
operate the first artificial intelligence (AI) model to assign at least one shopper characteristic tag from among the plurality of shopper characteristic tags to the another shopper based upon the further product purchase history; and
determine the digital promotion for the given shopper based upon matching the at least one shopper characteristic tag for the given and further shoppers and the at least one product characteristic tag.

12. The promotion processing server of claim 10 wherein the processor is configured to:
obtain a further product purchase history associated with another shopper; and
operate the first artificial intelligence (AI) model to assign the at least one shopper characteristic tag to the given shopper based upon the further product purchase history.

13. The promotion processing server of claim 10 wherein the processor is configured to operate at least one of the first and second AI models based upon bootstrap aggregation.

14. The promotion processing server of claim 10 wherein the processor is configured to determine a plurality of digital promotions including the digital promotion for the given shopper based upon matching the at least one shopper characteristic tag and the at least one product characteristic tag, rank the plurality of digital promotions based upon the at least one matched shopper characteristic tag and the at least one product characteristic tag, and communicate the ranked plurality of digital promotions to the shopper device.

15. A method of processing a digital promotion comprising:
using a promotion processing server to
obtain a product purchase history associated with a given shopper,
operate a first artificial intelligence (AI) model to assign at least one shopper characteristic tag from among a plurality of shopper characteristic tags to the given shopper based upon the product purchase history,
operate a second AI model to assign at least one product characteristic tag from among a plurality of product characteristic tags to a plurality of products for purchase,
determine a digital promotion for the given shopper based upon matching the at least one shopper characteristic tag and the at least one product characteristic tag, and
communicate the digital promotion to a shopper device associated with the given shopper.

16. The method of claim 15 wherein using the promotion processing server comprises using the promotion processing server to:
obtain a further product purchase history associated with another shopper; and
operate the first artificial intelligence (AI) model to assign the at least one shopper characteristic tag to the given shopper based upon the further product purchase history.

17. The method of claim 15 wherein using the promotion processing server comprises using the promotion processing server to operate at least one of the first and second AI models based upon bootstrap aggregation.

18. The method of claim 15 wherein using the promotion processing server comprises using the promotion processing server to determine a plurality of digital promotions including the digital promotion for the given shopper based upon matching the at least one shopper characteristic tag and the at least one product characteristic tag, rank the plurality of digital promotions based upon the matched at least one shopper characteristic tag and at least one product characteristic tag, and communicate the ranked plurality of digital promotions to the shopper device.

19. A non-transitory computer readable medium for processing a digital promotion, the non-transitory computer readable medium comprising computer executable instructions that when executed by a processor cause the processor to perform operations comprising:
obtaining a product purchase history associated with a given shopper;
operating a first artificial intelligence (AI) model to assign at least one shopper characteristic tag from among a plurality of shopper characteristic tags to the given shopper based upon the product purchase history;
operating a second AI model to assign at least one product characteristic tag from among a plurality of product characteristic tags to a plurality of products for purchase;
determining a digital promotion for the given shopper based upon matching the at least one shopper characteristic tag and the at least one product characteristic tag; and
communicating the digital promotion to a shopper device associated with the given shopper.

20. The non-transitory computer readable medium of claim 19 wherein the operations comprise:
obtaining a further product purchase history associated with another shopper; and
operating the first artificial intelligence (AI) model to assign the at least one shopper characteristic tag to the given shopper based upon the further product purchase history.

21. The non-transitory computer readable medium of claim 19 wherein the operations comprise operating at least one of the first and second AI models based upon bootstrap aggregation.

22. The non-transitory computer readable medium of claim 19 wherein the operations comprise determining a plurality of digital promotions including the digital promotion for the given shopper based upon matching the at least one shopper characteristic tag and the at least one product characteristic tag, rank the plurality of digital promotions based upon the matched at least one shopper characteristic tag and at least one product characteristic tag, and communicate the ranked plurality of digital promotions to the shopper device.
